(19) United States
(12) Patent Application Publication
(10) Pub. No.: US 2012/0079435 A1
(43) Pub. Date: Mar. 29, 2012

(54) INTERACTIVE PRESENTAION CONTROL SYSTEM

(75) Inventor: PING-YANG CHUANG, Tu-Cheng (TW)

(73) Assignee: HON HAI PRECISION INDUSTRY CO., LTD., Tu-Cheng (TW)

(21) Appl. No.: 12/958,272

(22) Filed: Dec. 1, 2010

(30) Foreign Application Priority Data
Sep. 23, 2010 (TW) 99132201

(51) Int. Cl. G06F 3/01

(52) U.S. Cl. 715/863

(57) ABSTRACT

An interactive presentation control system includes a computer, a projection screen, a computer-controlled projector, and a presentation control device. The projector projects images generated by the computer onto the projection screen. The presentation control device includes a storage unit, an image capturing unit, and a processing unit. The storage unit stores a control table recording relationship between gesture shadow patterns and control commands Each gesture shadow pattern corresponds to one control command. The image capturing unit captures an image of the projection screen periodically. The processing unit processes the captured image to determine whether the captured image includes a gesture shadow pattern, and determine the corresponding control command if the determined gesture shadow pattern is recorded in the control table. The processing unit further generates a control signal corresponding to the determined control command, and transmits the control signal to the computer through the communication unit.

### RELATED APPLICATION

The subject matter disclosed in this application is related to subject matter disclosed in a related application entitled, “PROJECTOR AND PROJECTION CONTROL METHOD”, filed Oct. 6, 2010 (Atty. Docket No. US31139), and assigned to the same assignee as named herein.

### BACKGROUND

1. Technical Field

The present disclosure relates to presentation systems using a computer, a computer-controlled image projector, and a projection screen and, particularly, to an interactive presentation control system in which control is accomplished by using gestures to form shadows on the projection screen.

2. Description of Related Art

Charts, text, and various graphical images are commonly presented to audience in meetings and in classrooms by projecting these images onto a projection screen or a wall. The charts, text, and graphical images are generated by a computer, such as a personal computer (PC) or a laptop computer, and projected onto the projection screen or the wall through a projector. A conventional projection system requires an operator to return to the computer, or to have an assistant seated at the computer, so as to provide control for a presentation. The actions of the operation moving to the computer, or communicating with the assistant, detract from a natural progression and flow of the presentation. It is known in the art to use a laser pointer to project a laser spot onto a region of the presentation image. Such systems typically require multiple steps or actions to be taken in exercising control over the presentation, and this serves to inhibit a natural progression and flow of the presentation.

### BRIEF DESCRIPTION OF THE DRAWINGS

The components of the drawings are not necessarily drawn to scale, the emphasis instead being placed upon clearly illustrating the principles of an interactive presentation control system. Moreover, in the drawings, like reference numerals designate corresponding parts throughout several views.

FIG. 1 is a schematic view of an interactive presentation control system in accordance with an exemplary embodiment.

FIG. 2 is a block diagram of a presentation control device of the interactive presentation control system of FIG. 1.

FIGS. 3A-3C are schematic views showing changes of images displayed on a projection screen of the interactive presentation control system of FIG. 1.

### DETAILED DESCRIPTION

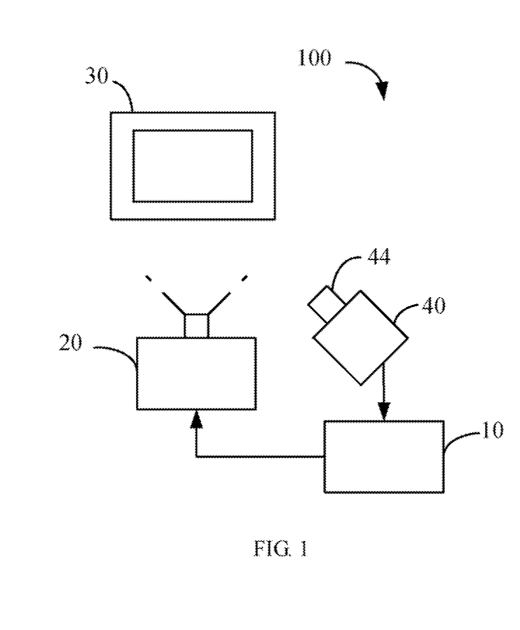

Referring to FIG. 1, an embodiment of an interactive presentation control system 100 is illustrated. The system 100 includes a computer 10, a computer-controlled projector 20, a projection screen 30, and a presentation control device 40. During operation of the system 100, the computer 10 generates images from the presentation being run by the presentation generating software, such as Microsoft PowerPoint®, resident in the computer 10, and the images are projected onto the projection screen 30 through the projector 20.

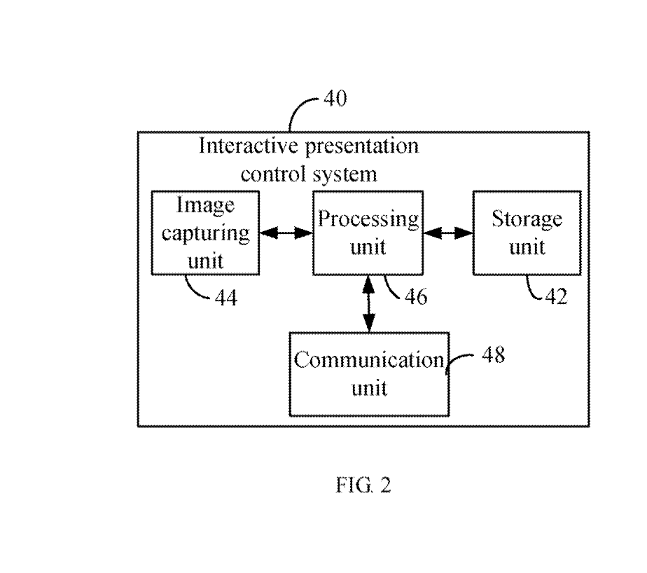

Referring to FIG. 2, the device 40 includes a storage unit 42, an image capturing unit 44, a processing unit 46, and a communication unit 48. The device 40 communicates with the computer 10 through the communication unit 48. The communication unit 48 may include any one or more of a BLUETOOTH unit, an infrared unit, a USB interface, and a WIFI unit, for example.

The storage unit 42 stores a control table recording relationship between gesture shadow patterns and control commands. As shown below, in the control table, each gesture shadow pattern corresponds to one control command The gesture shadow patterns include a single hand shadow pattern, a cross-hand shadow pattern, and so on. The control commands include turning to a previous page, turning to a next page, flipping pages, and so on.

Control Table

| | |
|---|---|
| Gesture Shadow Pattern | Control Command |
| First Gesture Shadow Pattern | First Control Command |
| Second Gesture Shadow Pattern | Second Control Command |
| . . . | . . . |

The projection screen 30 is within the lens scope of the image capturing unit 44. The image capturing unit 44 may be a digital cameral. The image capturing unit 44 periodically captures an image of the projection screen 30, thus content on the projection screen 30 is periodically obtained by the image capturing unit 44. The processing unit 46 processes the captured image using known image algorithm to determine whether the captured image includes a gesture shadow pattern. In this embodiment, if a presenter makes a gesture, such as raising a hand, within the projection scope of the projector 20, a distinctive shadow associated with the gesture may be formed on the projection screen 30. The processing unit 46 further determines the corresponding control command if the determined gesture shadow pattern is recorded in the control table, generates a control signal corresponding to the determined control command, and transmits the control signal to the computer 10 through the communication unit 48. The computer 10 then executes control over the presentation according to the control signal, turning to a next page for example.

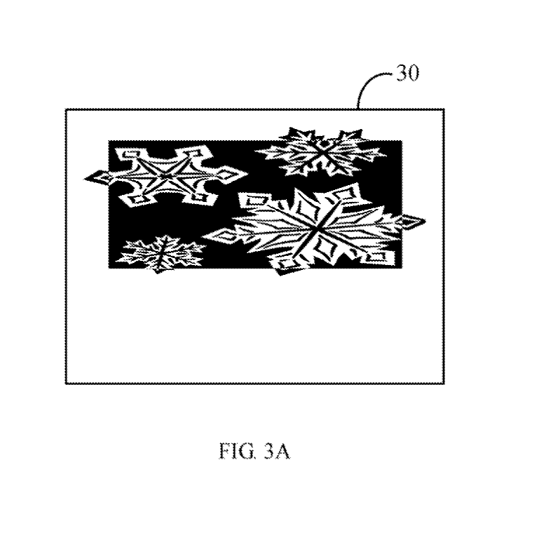

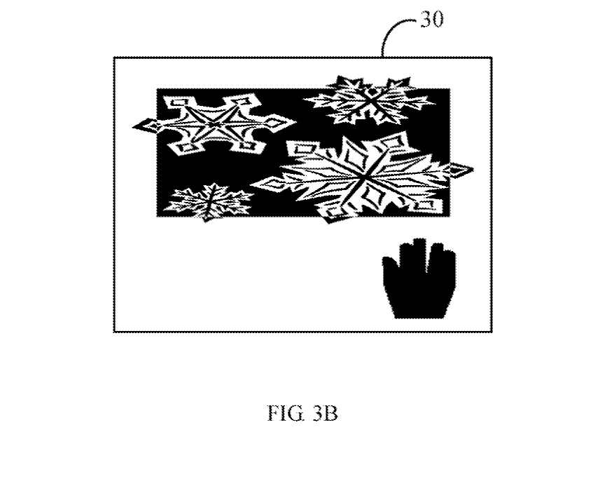

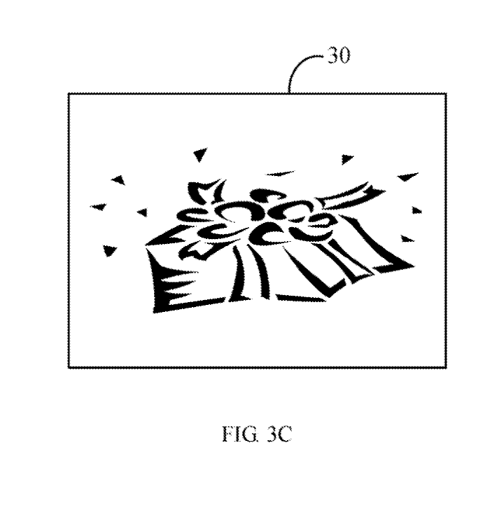

FIGS. 3A-3C are given to specifically illustrate the present disclosure. In this embodiment, the single hand shadow pattern corresponds to turning to a previous page. FIG. 3A shows a page of a presentation is displayed on the projection screen 30. FIG. 3B shows a shadow of a single hand of the presenter on the projection screen 30. The processing unit 46 determines that the shadow is the gesture pattern of the single hand, and determines that the control command is turning to a previous page. The processing unit 46 then generates a control signal corresponding to turning to a previous page, and transmits the control signal to the computer 10 through the communication unit 48. The computer 10 then displays the previous page of the presentation on the projection screen 30 through the projector 20.

With such configuration, the presenter can control content displayed on the projection screen 30 by making various gestures within the projection scope of the projector 30, which enhances a natural progression and flow of the presentation.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An interactive presentation control system, comprising:
a presentation control device comprising:
a storage unit storing a control table recording relationship between gesture shadow patterns and control commands, each of the gesture shadow patterns corresponding to one of the control commands;
an image capturing unit to capture an image of a projection screen periodically;
a communication unit to communicate the presentation control device with a computer; and
a processing unit to process the captured image to determine whether the captured image comprises a gesture shadow pattern, determine the corresponding control command if the determined gesture shadow pattern is recorded in the control table, generate a control signal corresponding to the determined control command, and transmit the control signal to the computer through the communication unit.

2. The interactive presentation control system as described in claim 1, wherein the communication unit comprises a unit selected from a group consisting of a BLUETOOTH unit, an infrared unit, a USB interface, and a WIFI unit.

3. The interactive presentation control system as described in claim 1, wherein the gesture shadow patterns comprise a single hand shadow pattern and a cross-hand shadow pattern.

4. The interactive presentation control system as described in claim 1, wherein the control commands comprise turning to a next page, turning to a previous page, and flipping pages.
